(19) United States
(12) Patent Application Publication
(10) Pub. No.: US 2018/0252355 A1
(43) Pub. Date: Sep. 6, 2018

(54) SUPPORT FOR ELECTRONIC DEVICE

(71) Applicant: ASUSTEK COMPUTER INC., Taipei City (TW)

(72) Inventors: Yi-Ting CHEN, Taipei City (TW); Tsung-Ju CHIANG, Taipei City (TW); Yu-Jui LIANG, Taipei City (TW)

(21) Appl. No.: 15/911,368

(22) Filed: Mar. 5, 2018

(30) Foreign Application Priority Data
Mar. 6, 2017 (TW) 106107175

(51) Int. Cl. F16M 13/00; G06F 1/16

(52) U.S. Cl. CPC F16M 13/005; G06F 1/1681

(57) ABSTRACT

A support comprises a base and a support portion. The base includes four sides and each side includes an opening. The support portion is connected to the base and includes four pivoting elements and four bending brackets. Each pivoting element is disposed in each opening, and the bending brackets are connected with each other through the pivoting elements to form an annular bracket. One of the bending brackets is fixed to the base, and the other three bending brackets are detachably disposed on the base.

### CROSS-REFERENCE TO RELATED APPLICATION

This application claims the priority benefit of Taiwan application serial No. 106107175, filed on Mar. 6, 2017. The entirety of the above-mentioned patent application is hereby incorporated by reference herein and made a part of specification.

### BACKGROUND OF THE INVENTION

### 1. Field of the Invention

The disclosure relates to a support and, more particularly, to a support of an electronic device.

### 2. Description of Related Art

Recently, portable electronic devices have been widely used. The portable electronic device is often applied with a support for stand on a surface. For example, in conventionally, a protective cover for the portable electronic device is folded to be a stand of the electronic device, or an attached bracket is added on the back of the electronic device to support the electronic device.

However, the conventional supports can only be erected in a single direction and cannot provide other directions. In addition, the appearance of the electronic device that equipped with the support cannot have an evenness surface.

### BRIEF SUMMARY OF THE INVENTION

According to an aspect of the disclosure, a support is provided herein. The support comprises a base, and a support portion. The base includes four sides, and each side includes an opening. The support portion is connected to the base. The support portion includes four pivoting elements and four bending brackets, each of the pivoting elements is disposed in each opening of the four sides of the base, and the four bending brackets are connected to form an annular bracket through the pivoting elements. One of the bending brackets is fixed to the base, and the other three bending brackets are detachably disposed on the base.

Therefore, in response to the screen of the electronic device being changed between the horizontal mode and the vertical mode, the support of the present invention can erect along two axes, that is, along the X axis and the Y axis to support the electronic device. In this way, the user can erect the electronic device in the horizontal mode and the vertical mode and view and operate the electronic device ergonomically.

### BRIEF DESCRIPTION OF THE DRAWINGS

FIG. 1 and FIG. 2 is a front exploded view and a rear exploded view of the support in an embodiment;

FIG. 3 shows the folded state of the support in an embodiment;

FIG. 4 and FIG. 5 show a state of the support rotates along the Y axis and erects;

FIG. 6 shows a state of the support rotates along the X axis and erects;

FIG. 7 and FIG. 8 show the application of the support of an embodiment;

FIG. 9 shows that the support of an embodiment is fixed with a flexible sheet; and

FIG. 10 to FIG. 13 show other shapes of the support according to an embodiment.

### DETAILED DESCRIPTION OF THE EMBODIMENTS

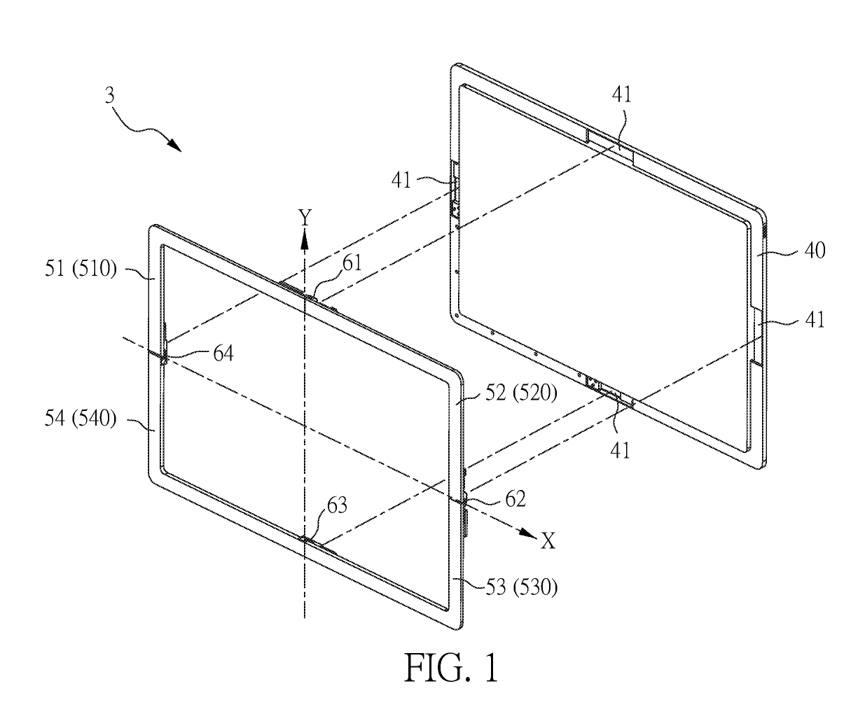

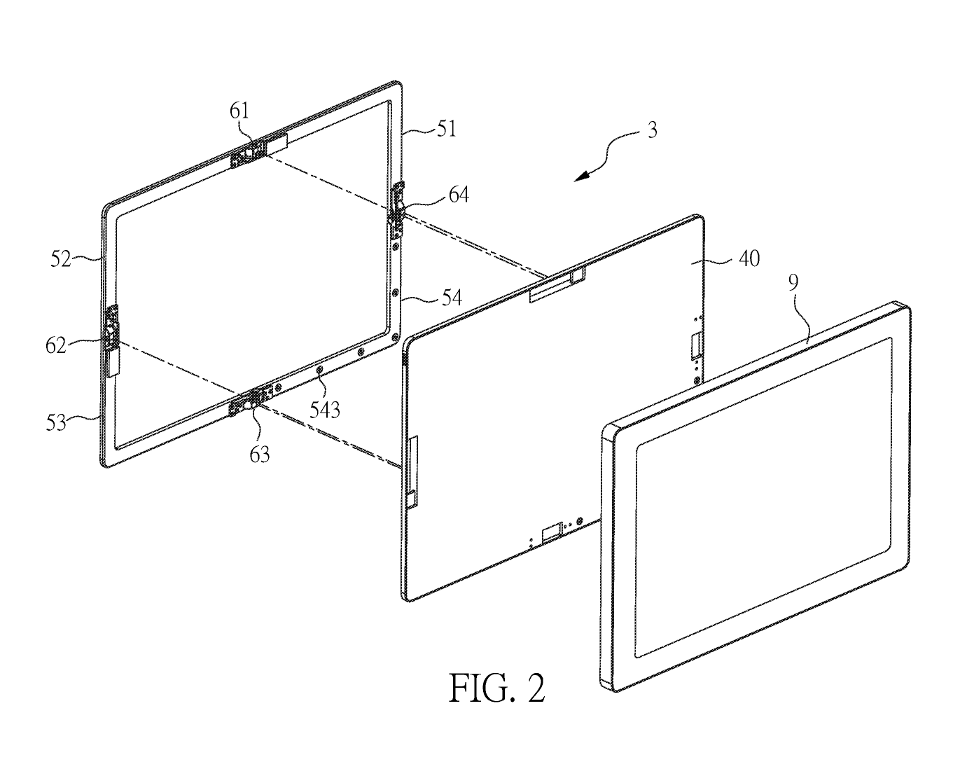

FIG. 1 and FIG. 2 respectively show a front exploded view and a rear exploded view of the support 3 of the present invention. As shown in FIG. 1 and FIG. 2, the support 3 includes a base 40 and four L-shaped brackets 51-54. In other embodiments, the L-shaped bracket may also be replaced by a curved bracket such as a C-shaped bracket, a quarter-circular bracket, a triangular bracket or a rectangular bracket, which is not limited herein.

The material of the base 40 is copper, iron, aluminum, stainless steel or alloy thereof, or glass, plastic or acrylic. As shown in FIG. 1, the base 40 has four sides of up, down, left and right. Each side has an opening 41. The four openings 41 are used to dispose the pivoting elements 61 to 64.

The four L-shaped brackets 51 to 54 are preferably composed of a rigid sheet. The rigid sheet is copper, iron, aluminum, stainless steel or alloys thereof, or glass, plastic or acrylic. The rigid sheet provides sufficient supporting force and makes the whole electronic device thinner in dimension.

As shown in FIG. 2, the four L-shaped brackets 51 to 54 are connected by four pivoting elements 61 to 64. In detail, the first L-shaped bracket 51 is connected to the second L-shaped bracket 52 via the first pivoting element 61. The second L-shaped bracket 52 is connected to the third. L-shaped bracket 53 via the second pivoting element 62. The third L-shaped bracket 53 is connected to the fourth L-shaped bracket 54 via the third pivoting element 63. The fourth L-shaped bracket 54 is connected to the first L-shaped bracket 51 via the fourth pivoting element 64 to form an annular bracket.

Only the fourth L-shaped bracket 54 is fixed to the base 40, which can be fixed by a plurality of fasteners 543 or by the third pivoting element 63 and the fourth pivoting element 64. The other three L-shaped brackets 51 to 53 are configured for stand up.

The two ends of each L-shaped bracket are integrally formed. The support 3 is a rectangular or a square by adjusting the length of the two ends of each L-shaped bracket.

The support 3 has a folded state, a first erected state and a second erected state.

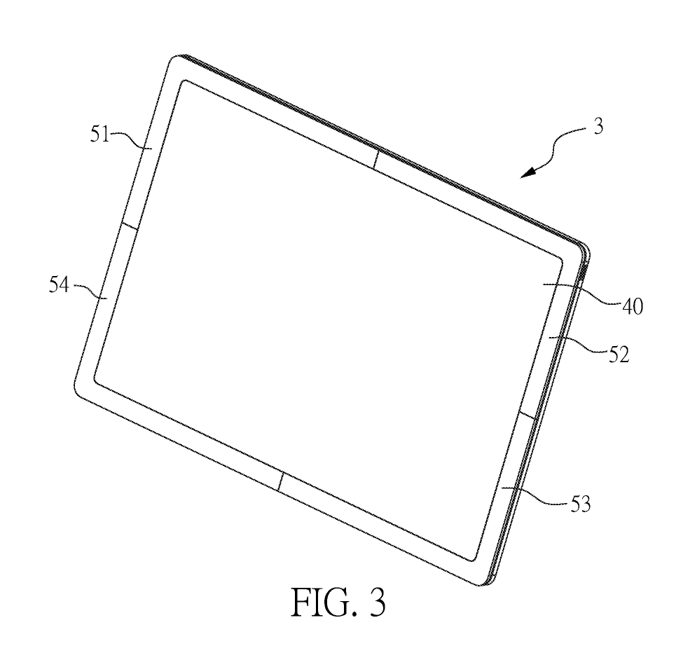

FIG. 3 shows the folded state of the support 3. In the folded state, all four L-shaped brackets 51 to 54 are received in the base 40.

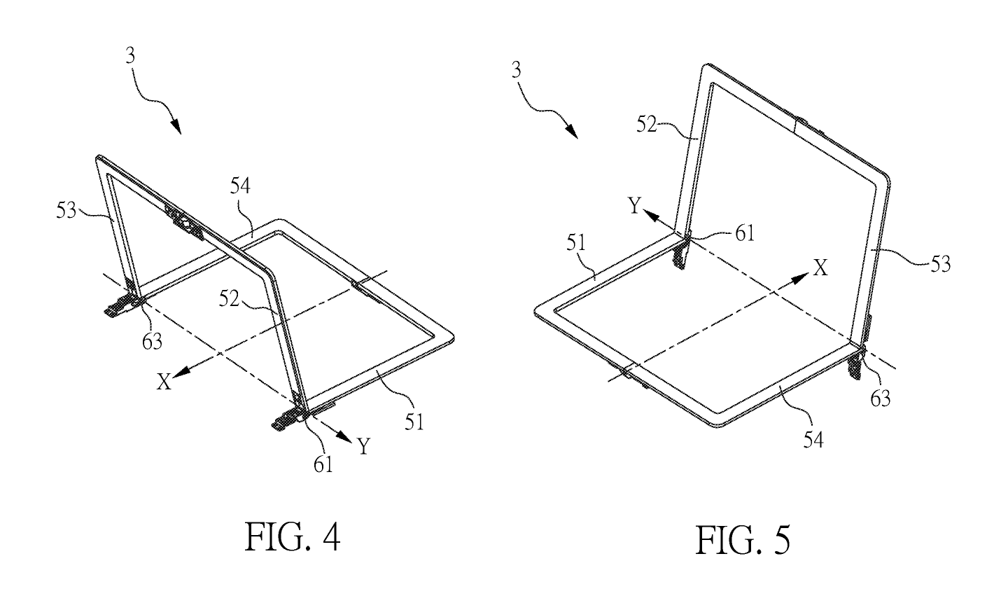

FIG. 4 and FIG. 5 show a state of the support 3 pivots along the Y axis and erects. In the first erected state, the second L-shaped bracket 52 is pivoted by the first pivoting element 61, and the third L-shaped bracket 53 is pivoted by the third pivoting element 63. The second L-shaped bracket 52 and the third L-shaped bracket 53 are erected simultaneously. The first L-shaped bracket 51 and the fourth L-shaped bracket 54 keeps contacted with the base 40.

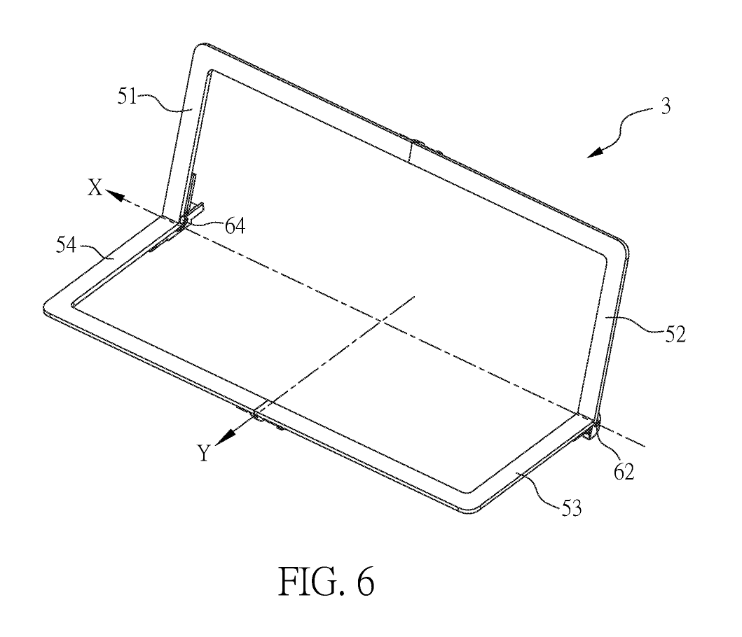

FIG. 6 shows a state of the support 3 pivots along the X axis and erects. In the second standing state, the first L-shaped bracket 51 is pivoted by a fourth pivoting element 64, the second L-shaped bracket 52 is pivoted by the second pivoting element 62. The first L-shaped bracket 51 and the second L-shaped bracket 52 are erected simultaneously. The third L-shaped bracket 53 and the fourth L-shaped bracket 53 keeps contacted with the base 40.

Please refer to FIG. 5, when the support 3 pivots along the Y axis, the first pivoting element 61 and the third pivoting element 63 provide a pivoting function, and the second pivoting element 62 and the fourth pivoting 64 provide a supporting function. Similarly, when the support 3 pivots along the X-axis, the second pivoting element 62 and the fourth pivoting element 64 provide the pivoting function, and the first pivoting element 61 and the third pivoting element 63 provide the supporting function.

Therefore, when the support 3 pivots along different axes, the bending brackets do not interfere with each other, so the electronic device 9 can be stably supported without being damaged by accident while operation. In an embodiment, each pivoting element provides a stepless pivoting function or a pivoting function through a multi-segment gearing engagement mechanism, which is not limited herein.

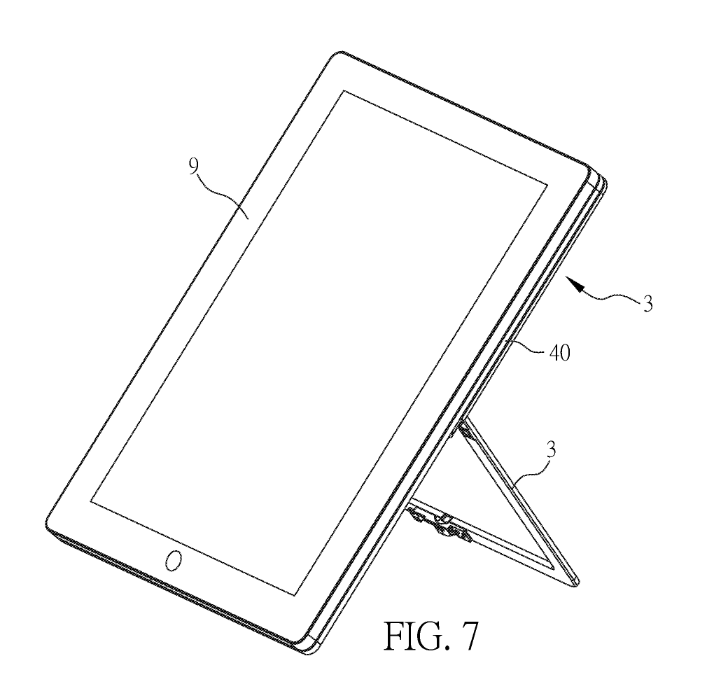

Therefore, in response to that the screen of the electronic device 9 can be changed between the horizontal mode and the vertical mode, the support 3 of the present invention can erect along two axes, that is, along the X axis and the Y axis to support the electronic device 9. FIG. 7 and FIG. 8 show the application of the support 3 of the present invention. In this way, the user can erect the electronic device 9 in the horizontal mode or the vertical mode to view and operate ergonomically.

The main features of the support 3 of the present invention has been described, other optional or preferred features will be further described as follows, including:

The base 40 may be rectangular or square corresponding to the rectangular or square support 3 such that four L-shaped brackets 51-54 may be disposed along the lateral edges of the base 40.

In an embodiment, the base 40 is an individual accessory that separated from the electronic device 9. The surface of the base 40 where the electronic device 9 placed is provided with a groove for fixing the electronic device 9. In an embodiment, the base 40 is a part of the housing or is the housing of the electronic device 9, where the supporting 3 matches the size of the electronic device 9 and is not easy to fall off.

In an embodiment, the four L-shaped brackets 51-54 is provided with cover sheets 510-540 to shield each pivoting element, as shown in FIG. 1. The occurrence of pinching hand is avoided, and the pivoting element is avoided from exposing to keep the beautiful appearance. In an embodiment, the cover sheet is integrally formed with the L-shaped bracket. In an embodiment, the cover sheet is longer than the length of each L-shaped bracket to cover the pivoting member.

In an embodiment, the bending part of the four L-shaped brackets 51 to 54 is a right angle or an arc-shaped.

The four pivoting elements 61-64 are composed of a hinge shaft and a hinge cylinder, and is gearing engaged. In an embodiment, the hinge shaft has elastic inserts distributed interval on its cylindrical surface. The hinge cylinder has a plurality of grooves distributed interval on its inner surface. When the hinge shaft is pivoted to a specific angle, the elastic insert engages to one of the grooves; thereby the raised L-shaped bracket is fixed at a particular angle. When the user applies force to rotate the L-shaped bracket, the elastic insert slides out of the groove and release the engagement for pivoting.

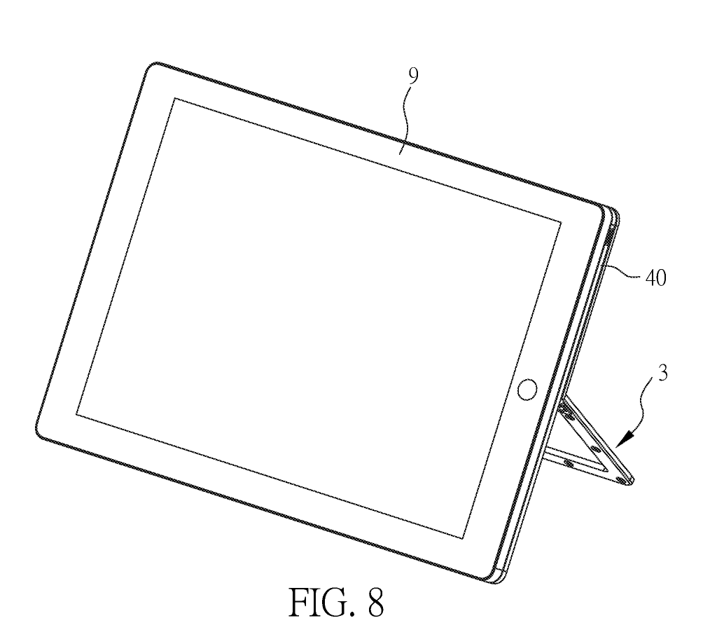

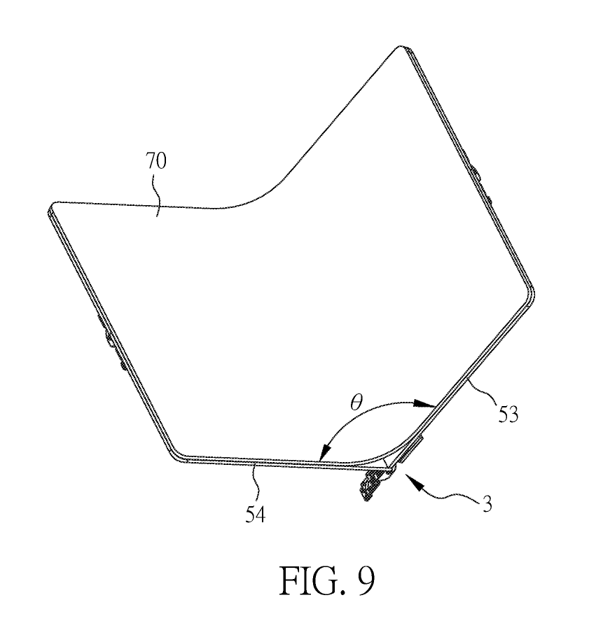

In addition, in other embodiments, the flexible sheet 70 is fixed to the support 3, that is, to the four L-shaped brackets 51 to 54. FIG. 9 shows that the support 3 is fixed with the :flexible sheet 70. The flexible sheet 70 is made of a flexible material such as plastic, silicone, rubber, cloth, leather, synthetic leather, or paper. The flexible sheet 70 is preferably stretchable. The flexible sheet also provides both protection and decoration to the electronic device. In an embodiment the fixing manner that the :flexible sheet 70 fixed to the support 3is pasting or nailing, which is not limiting herein.

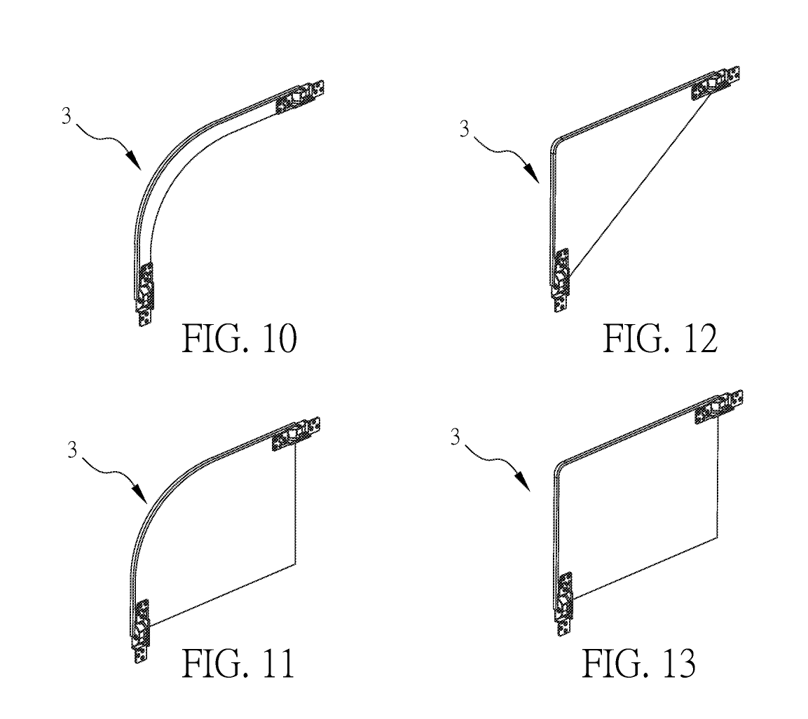

FIG. 10 to FIG. 13 show other embodiments of the support. FIG. 10 shows a C-shaped support in an embodiment. FIG. 11 shows a quarter-circular support in an embodiment. FIG. 12 shows a triangular support in an embodiment. FIG. 13 shows a rectangular support in an embodiment, which is not limited herein. Each L-shaped bracket can be replaced with a bracket of the above shape separately or simultaneously.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A support, comprising:
a base, including four sides, and each side including an opening; and
a support portion, connected to the base, the support portion including four pivoting elements and four bending brackets, each of the pivoting elements disposing in each opening of the four sides of the base, and the four bending brackets connected to form an annular bracket through the pivoting elements;
wherein one of the bending brackets is fixed to the base, and the other three bending brackets are detachably disposed on the base.

2. The support according to claim 1, wherein two pivoting elements connecting to two end of the bending bracket that fixed to the base are fixed to the base.

3. The support according to claim 1, wherein each bending bracket is provided with two cover sheets to shield each pivoting element.

4. The support according to claim. 1, wherein each pivoting element consists of a hinge shaft and a hinge cylinder.

5. The support according to the claim 1, wherein each pivoting element includes a multi-segment gearing engagement mechanism.

6. The support according to the claim 1, wherein the bending part of the bending brackets is a right angle or arc-shaped.

7. The support according to the claim 1, wherein the annular bracket or the base is a rectangular or a square.

8. The support according to the claim 1, wherein the base is a part of the housing of the electronic device.

9. The support according to the claim 1, wherein the support further includes a flexible sheet covering the bending brackets.

10. The support according to the claim 1, wherein the support has a folded state, a first erected state and a second erected state;
in the folded state, the bending brackets are received in the base;
in the first erected state, the support stand is erected in a first direction; and
in the second erected state, the supporting frame is erected in a second direction, and the second direction is perpendicular to the first direction.
